(19) United States
(12) Patent Application Publication
(10) Pub. No.: US 2018/0161845 A1
(43) Pub. Date: Jun. 14, 2018

(54) HYDRAULIC TOOL

(71) Applicant: REFCO Manufacturing Ltd., Hitzkirch (CH)

(72) Inventors: Manfred ULRICH, Hitzkirch (CH); Ulrich DEMUTH, Erbach (DE)

(73) Assignee: REFCO Manufacturing Ltd., Hitzkirch (CH)

(21) Appl. No.: 15/473,984

(22) Filed: Mar. 30, 2017

Related U.S. Application Data
(60) Provisional application No. 62/349,842, filed on Jun. 14, 2016.

(30) Foreign Application Priority Data
Mar. 30, 2016 (DE) 20 2016 001 951.2

(51) Int. Cl. B21D 41/02; F15B 11/10; F15B 13/02; F15B 15/02; F15B 15/14

(52) U.S. Cl. CPC B21D 41/026; F15B 11/10; F15B 13/025; F15B 15/02; F15B 2211/857; F15B 2211/20507; F15B 2211/50509; F15B 2211/523; F15B 2211/7052; F15B 15/14

(57) ABSTRACT

A hydraulic tool including a tank, which is filled with oil, a hand pump connected to the tank in fluid communication, having a spring-loaded lever mechanism, which is in operative connection with a pump piston, with a piston cylinder system as actuator, which is connected to the pump in fluid communication with a non-return valve, wherein the piston surface of the actuator is a multiple of the piston surface of the hand pump.

This nonprovisional application claims priority to U.S. Provisional Application No. 62/349,842, which was filed on Jun. 14, 2016, and which claims priority to German Patent Application No. 20 2016 001 951.2, which was filed in Germany on Mar. 30, 2016, and which are both herein incorporated by reference.

### BACKGROUND OF THE INVENTION

### Field of the Invention

The present invention relates to a hydraulic hand-held device for the generation of force, wherein via a hand pump, manual forces are multiplied, and wherein the operation of the hydraulic part is optimized.

### SUMMARY OF THE INVENTION

It is an object of the invention to provide a cost effective solution for handling the above-mentioned hydraulic handset. In addition, a design shall be created that enables simple service and allows for the adjustment of the hydraulic force to an application.

According to an embodiment of the invention, the device has an optimized hydraulic path, an optimized lever mechanism, a new tank/handle design and further improvements for handling force transmission for manually operated tools.

According to an exemplary embodiment of the invention, a hydraulic tool is provided, which comprises at least one tank which is filled with a fluid, a pump unit, in particular a hand pump, which is connected in fluid communication with the tank, with a pump piston having a pump piston surface, and an actuator, in particular a piston cylinder unit or system, which is in fluid communication with the pump unit. On the actuator, a receiving unit can be mounted or is formed, which forms a stop for an actuator piston with an actuator piston surface and/or on which a mechanical tool can be mounted, wherein the actuator piston surface is a multiple of the pump piston surface. The pump unit, when activated by the receiving unit, enters into operative connection with the mechanical tool.

The advantages which can be achieved with the hydraulic tool include, in particular, in that a force applied to the manual pump unit (hand pump) is amplified on the actuator corresponding to the multiple. The achievable end pressure on the actuator when the pump unit is manually operated by a human hand is 200 bar to 750 bar, in particular 300 bar to 600 bar, preferably 350 bar to 500 bar. The end pressure can be detected, for example, by means of a conventional pressure measuring device, in particular by means of a pressure sensor, for example a piezoelectric pressure sensor, which, in particular, directly converts the pressure to be detected into an electrical output variable proportional thereto.

The actuator is, for example, designed as an actuator piston cylinder system. At the head part of the hydraulic tool, in particular at the head part of the actuator piston cylinder system, a union nut is mounted, for example, as a receiving unit, or a tool holder is formed which forms the stop for the piston and/or can accommodate a mechanical tool, wherein actuators mounted on the pistons can be operatively connected to the mechanical tool via the union nut.

In this case, a maximum end position from the piston stop always results for a mounted mechanical tool on the union nut, regardless of the position of the union nut relative to the head part or actuator of the tool.

In addition, a mechanical tool can be accommodated on the head part of the tool, wherein the maximum opening or the maximum travel distance can be adjusted on a stop by inserting fittings or fitting rings.

Furthermore, the hydraulic tank can be enclosed or closed by an end cap, which is provided with a hexagonal hole at the end, and can be dismantled by means of a tool engagement from the handle part of the pump unit.

According to an embodiment, the hydraulic tool comprises at least one tank, which is filled with a fluid, a pump unit connected in fluid communication with the tank having a pump piston with a pump piston surface, and an actuator, which is in fluid communication with the pump unit, wherein on the actuator, a receiving unit can be mounted or is formed, which forms a stop for an actuator piston with an actuator piston surface and/or on which a mechanical tool can be mounted. The hydraulic tool additionally comprises at least one securing element for pressure limitation, for fluid exchange and/or for preventing twisting.

In an embodiment, the securing element, in particular a releasable closure, for example, a releasable closure ball or screw, engages in the actuator in such a way that a fluid exchange is possible. For example, the securing element is released from its sealing seat when the receiving unit is adjusted so that the fluid, for example oil, can be emptied safely from the hydraulic tool, in particular the tank and/or the actuator.

For example, as an actuator, the tool comprises an actuator piston cylinder system, which has a union nut on the head part of the tool as a receiving unit, wherein a cylinder space of the actuator piston cylinder system is outwardly provided with a channel bore, through which the hydraulic oil can be pumped out, wherein the channel bore is closed with a locking screw or ball or a molded part, which at the same time is in operative connection with the union nut.

In an embodiment, the securing element can engage in the receiving unit in such a way that the receiving unit is at least secured against twisting, in particular slipping or unintentional opening. For example, such a securing element is designed as a locking element, in particular a screw, a bolt or a pin or a round-pin or a form-locking element, which secures the receiving unit against twisting. The locking element engages in the receiving unit in such a way that the latter is locked against twisting relative to the tool, in particular the actuator and/or the pump unit. The receiving unit cannot be rotated and adjusted until the engagement of the locking element with the receiving unit has been released.

An embodiment of the hydraulic tool provides that the securing element engages in the fluid connection, in particular, between the actuator and the pump unit, such that a pressure limitation is made possible, and in particular, adjustable. For example, such a securing element is designed as an adjustable valve unit, in particular as an overpressure valve with an adjusting screw for setting a maximum pressure.

Depending on the function and design, the hydraulic tool may comprise only one or more of the above-described securing elements. For example, the hydraulic tool can include securing elements, the locking element and the releasable closure element. Alternatively, the hydraulic tool may comprise only the locking element or only the releasable closure element or only the adjustable valve unit. Also, the hydraulic tool may comprise all three securing elements.

Additionally or alternatively, the hydraulic tool may include a manometer that is fluidly coupled to one of the fluid connections of the tool. For example, the manometer may be fluidically coupled into the tank in a hydraulic return line from the actuator. This allows for the pressure in the actuator to be precisely monitored and adjusted.

For example, a piston chamber of the actuator can be connected to the manometer or to a pressure measuring device or a sensor or a pressure-limiting valve with which a maximum pressure in the actuator piston chamber can be controlled or adjusted or limited.

In an embodiment, the pump unit can have a spring-loaded lever mechanism which is operatively connected to the pump piston. In this case, the lever mechanism is designed to be adjustable so that the lever ratio can be adapted to the respective application of the hydraulic tool, for example, for expanding the pipe.

The position of a pump lever can thereby be adjusted by rotating a pump lever bearing pin. For example, the pump lever factor can be varied, wherein the pump lever factor has a length ratio of lever length to piston length in a range of 1:4 to 1:10, in particular 1:5 to 1:8. A hydraulic piston diameter can, for example, have a value in a range of 5 mm to 15 mm, preferably 8 mm to 12 mm.

In an embodiment, the receiving unit is designed as a union nut, which is mounted on an actuator piston cylinder unit (also known as an actuator piston cylinder system). In this case, the receiving unit, in particular the union nut, couples the pump unit, in particular the hand pump, and the actuator, to a mechanical tool that is to be fastened.

According to an embodiment of the hydraulic tool, this at least comprises a tank, which is filled with a fluid, a pump unit that is connected in fluid communication with the tank, and an actuator, wherein the actuator is in fluid communication with the pump unit and a fluid change device is provided, via which a fluid connection to the tank is adjustable without the use of tools. For example, the tool comprises a securing element, in particular a securing screw or ball, which can be released by means of the receiving unit, in particular the union nut.

According to an embodiment of the hydraulic tool, the latter at least comprises a tank, which is filled with a fluid, a pump unit, which is fluidly connected to the tank, and an actuator, which is in fluid communication with the pump unit, wherein the pump unit comprises a lever mechanism, of which the axis point is adjustable, which acts as an actuating element. As a result, the opening dimension of the lever, in particular of the handle, changes so that the pump unit can be easily adjusted for differently sized hands.

The illustrated embodiment shows attachments for expanding pipes but can also be equipped with pipe bending or pipe cutting or coning tools.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a sectional view of an embodiment of a hydraulic tool;

FIGS. 2 to 5 illustrate, in an enlarged sectional view, a hydraulic tool in the region of an actuator;

FIG. 6 illustrates in an exploded view, an embodiment for a hydraulic tool in the region of an actuator;

FIGS. 7 to 9 illustrate in a sectional view or a partial sectional view a hydraulic tool;

FIG. 10 illustrates, in a side view, an embodiment for a hydraulic tool in the assembled state.

### DETAILED DESCRIPTION

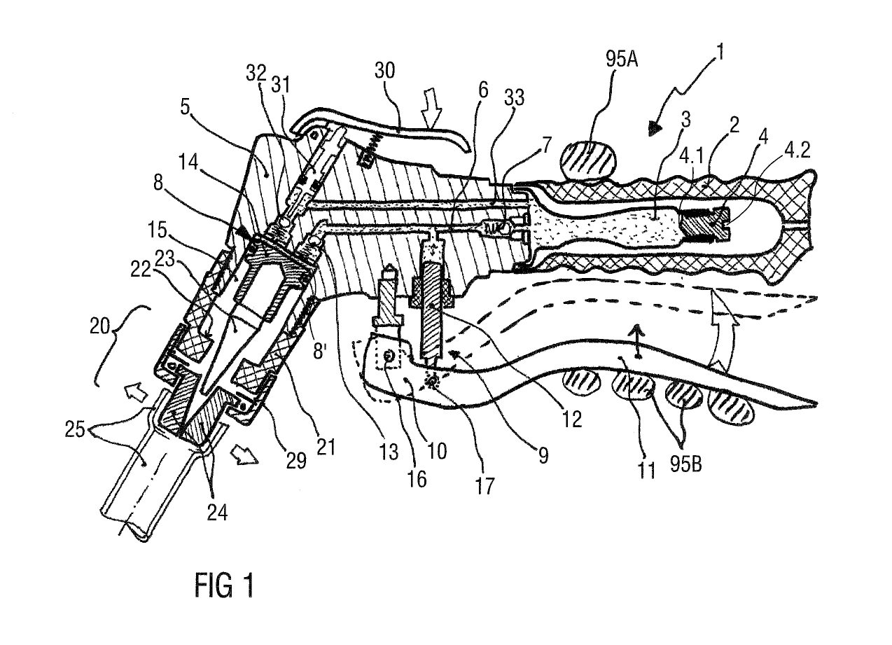

FIG. 1 shows as a device a hydraulic tool 1 in an embodiment.

The hydraulic tool 1 has a handle part 2 with an integrated tank 3. The tank 3 has a filling opening 4.1, which can be sealingly closed with an end cap designed as a filling screw 4. In this case, the end cap has a tool holder, in particular a hexagonal hole, on its end extending outwards 4.2.

The hydraulic tool 1 also includes an actuator 8 and a manual pump unit 9 (also called a hand pump). The pump unit 9 is in fluid communication with the tank 3. The actuator 8 in turn is in fluid communication with the pump unit 9 and the tank 3.

A suction line 6 for supplying the actuator 8, in particular an actuator piston cylinder system, by means of a hand pump 9, leads off from the tank 3 into a hydraulic or pump head 5 of the hydraulic tool 1. A non-return valve 7 is inserted in the suction line 6 for supplying the actuator 8.

The hand pump 9 comprises a spring-loaded lever mechanism 10. The lever mechanism 10 comprises, as a handle, a lever 11, which can be pivoted about an axis pivot point 16.

A pump piston 12 is in operative connection with the lever 11, wherein the former is in fluid communication with the actuator piston cylinder system as an actuator 8 and can pump a fluid, for example hydraulic oil, from the tank 3 via a second non-return valve 13 into the actuator 8, thus moving the actuator piston 14 in the cylinder chamber 15 of the actuator 8.

A piston surface of the actuator 8, in particular its size and/or surface, in this case is a multiple of the pump piston surface of the pump piston 12, in particular of its size and/or surface, of the hand pump 9. Accordingly, the force is transmitted and reinforced according to this ratio.

Numerals 95A and 95B show an example of an operating hand of the pump unit 9 in a sectional view.

Further amplifying the power ratio is the leverage factor, which is formed by the distance of the center of the gripping surface of the lever 11 to the axis pivot point 16 in relation to the distance between the piston engagement point 17 and the axis pivot point 16.

According to the lever principle, here, there is already an amplification of force, in addition to the piston surface ratio of the two piston systems.

The actuator piston 14 can then act on various tools such as also pipe bending or pressing tools. Shown here is a pipe expanding tool 20, which is mounted on, in particular screwed to, and held on a receiving unit 21, in particular a union nut 21. The receiving unit 21 closes off the cylinder chamber 15. An inner shoulder 22 serves as a stop for the actuator piston 14.

For example, a cone 23 connected to the actuator piston 14 runs through an inner opening 41 of the union nut 21. The cone 23 can then, for example, push apart pressing elements 24 of another tool, here a pipe expanding tool 20, in order to radially expand one end of a pipe 25 displayed here.

Furthermore, the actuator 8 can be connected to the tank 3 via a return line 33.

Via a drain valve lever 30, a drain valve 32 can then be opened via a piston 31, and as a result of a restoring force, in particular a pressure, which acts on the actuator piston 14, the fluid can be drained from the actuator 8 via the return line 33 back to the tank 3.

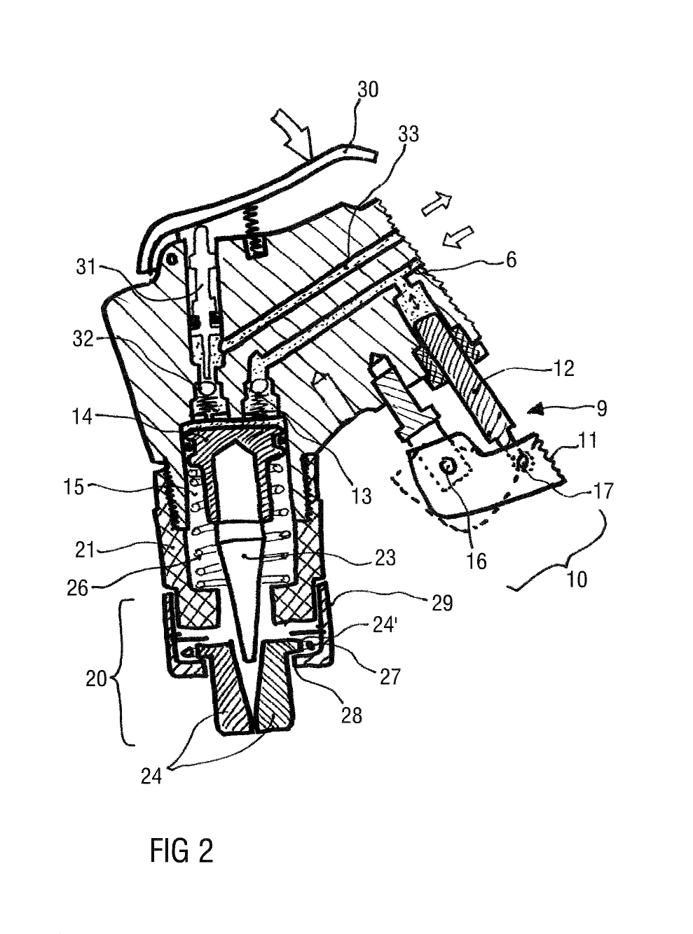

FIG. 2 is a view of the hydraulic or pump head 5, wherein here, the piston return spring 26 is also shown, which effects the restoring force upon actuation of the drain valve lever 30.

When the drain valve lever 30 is actuated and the valve 32 is opened, said piston return spring 26 returns the actuator piston 14 to its upper initial position and presses the fluid, in particular oil, back into the tank 3 via the return line 33.

Thereafter, the pipe 25 can again be removed from the expanding tool 20, since the cone 23 is also returned to its upper position. This causes the expander jaws, in particular the pressing elements 24, to again move together.

An annular spring 27 surrounding the jaws or pressing elements 24 at their upper ends further assists herewith. For cost-effectiveness, this annular spring 27 can also be designed as a rubber gasket.

The maximum amount of expansion for the jaws or pressing elements 24 is determined by an expanding or expansion stop 28 as the diameter of the tool attachment 29.

Furthermore, the piston return spring 26 is shown in this illustration, which can push the piston 31 back up to its starting position, and which then also presses the oil from the piston chamber 8′ via line 33 back into the tank 3.

In all following representations, however, this piston return spring 26 has been omitted for purposes of simplicity.

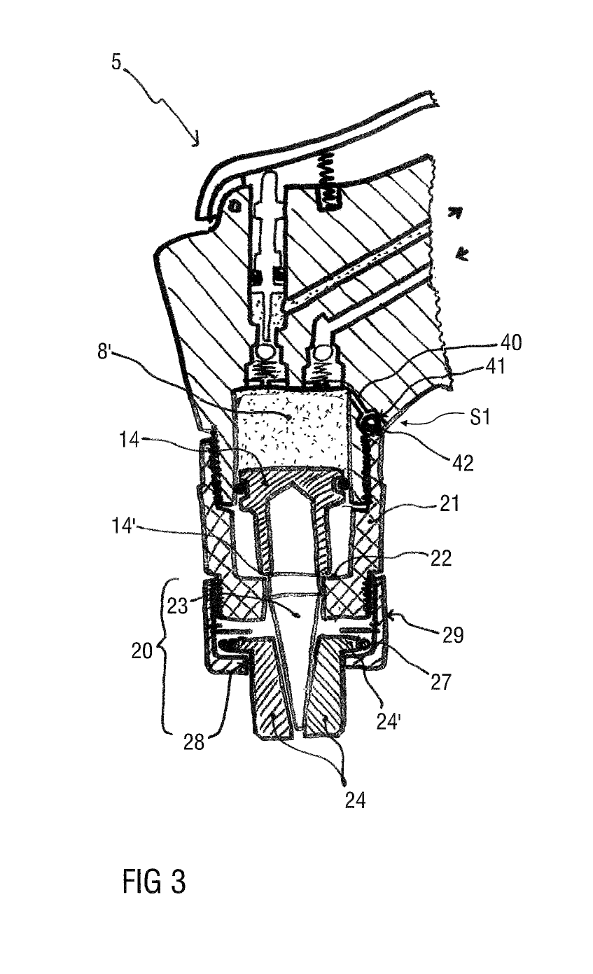

FIG. 3 shows an embodiment of the hydraulic tool 1 with an outlet for a simplified oil change.

For this purpose, the tool 1 comprises a releasable closure element 42 as a possible securing element S1. In the exemplary embodiment, the releasable closure element 42 is designed as a sealing ball. Furthermore, the releasable closure element 42 is called the sealing ball 42. Alternatively, the releasable closure element 42 may also be a sealing valve or other suitable releasable closure.

In this case, a channel bore 40 leads from the outside into the piston chamber 8′ of the piston cylinder system. The channel bore 40 expands outwardly into an outer opening 41. The opening 41 is formed as a widening with a conical sealing seat 75 by positioning the sealing ball 42 as a releasable closure element.

The sealing ball 42 preferably has a diameter of between 2 mm to 8 mm, 3 mm to 5 mm, or optimally 3.5 mm or 4.0 mm.

By threading the union nut 21, the sealing ball 42 is pressed tightly sealingly into its sealing seat 75 in the opening 41, thus closing off the system for normal operation.

As shown in this example, the actuator piston 14 can approach the stop or inner shoulder 22 of the union nut 21 with its shoulder 14′, and can then move the jaws or pressing elements 24 maximally up to the expansion stop 28 by means of the cone 23.

Even the smallest turn of the union nut 21 is sufficient to release the sealing ball 42 from its sealing seat 75 in the opening 41. When pumping, the oil is driven out of the channel bore 40 instead of driving the actuator piston 14.

This way, the tool 1 can be simply, reliably and cleanly emptied from the fluid, in particular oil, until the tank 3 is empty.

Thereafter, new fluid or oil can then be filled into the tank 3 as part of a fluid or oil change.

It is not even necessary to dismantle the additional attached tool 20, such as the exemplary pipe expanding tool 20.

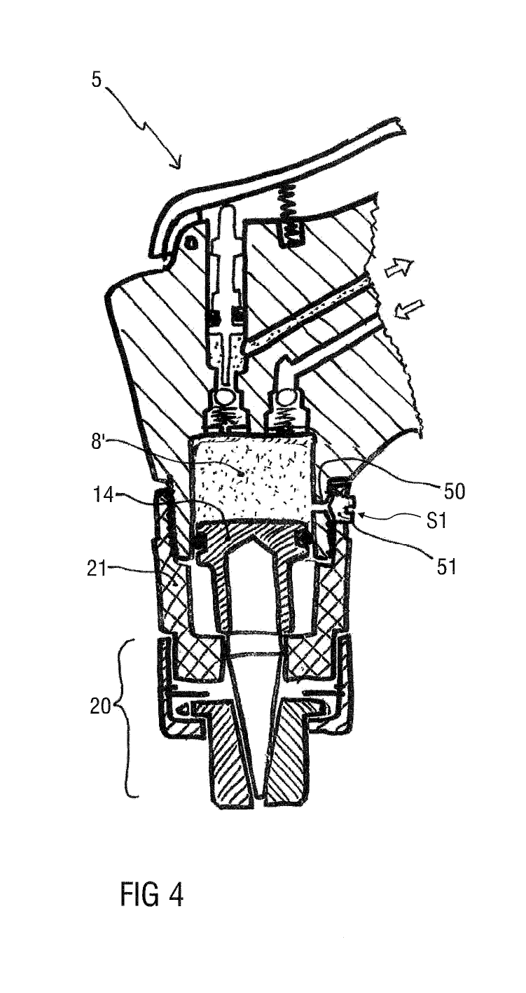

FIG. 4 shows another embodiment of the hydraulic tool 1 with an alternative outlet for a simplified fluid or oil change.

To this end, the tool 1 comprises as a possible securing element S1 a releasable sealing element, in particular a sealing screw 51.

Here, too, the additional tool 20 can be left on the union nut 21, since here, a central bore 50 reaches the piston chamber 8′ through the union nut 21 and is easily closed with the sealing screw 51.

To empty the tool 1, pumping only has to be carried out until the actuator piston 14 moves forward a little and has passed the bore 50 which is open at that time.

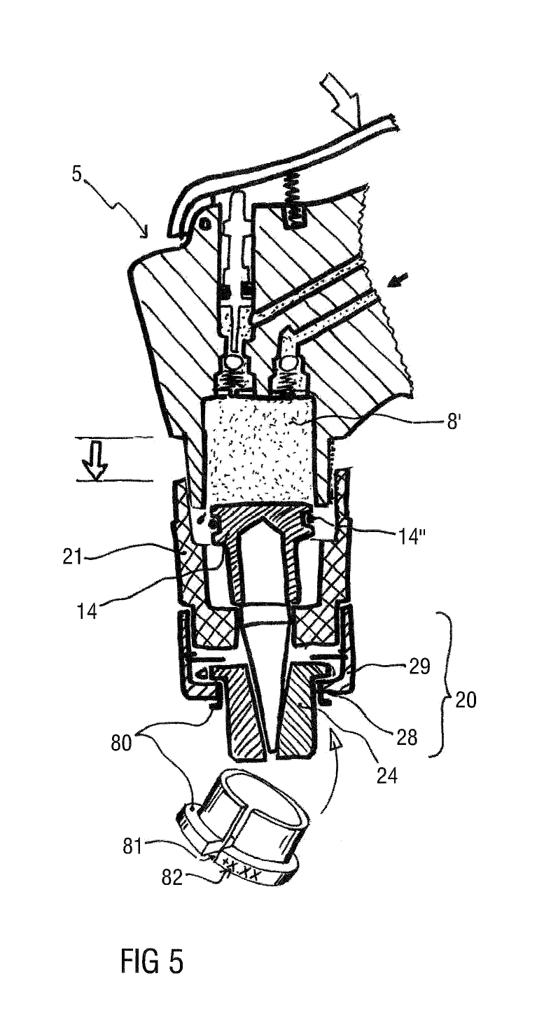

FIG. 5 shows the hydraulic tool 1 when changing the piston sealing ring.

For this purpose, the union nut 21 is first unscrewed a little. Then, the pump unit 9 pumps as long as needed until the actuator piston 14 is pressed from the piston chamber 8′.

Thereafter, the union nut 21 can be completely removed so that the piston sealing ring 14″ can be dismantled, removed and changed.

Furthermore, a possibility is shown how with different fitting rings, a maximum expansion, a travel path of the jaw inserts or pressing elements 24 of the additional tool 20 can be limited mechanically.

For this purpose, at the stop diameter of the expansion stop 28 of the tool 29, different fitting sleeves 80 can be used, which are preferably made of hardened spring steel and are provided with a slot 81 and can be inserted into the opening of the expansion stop 28 by gently squeezing and clamping. In this case, the fitting sleeves 80 may have a label 82 with respect to their strength.

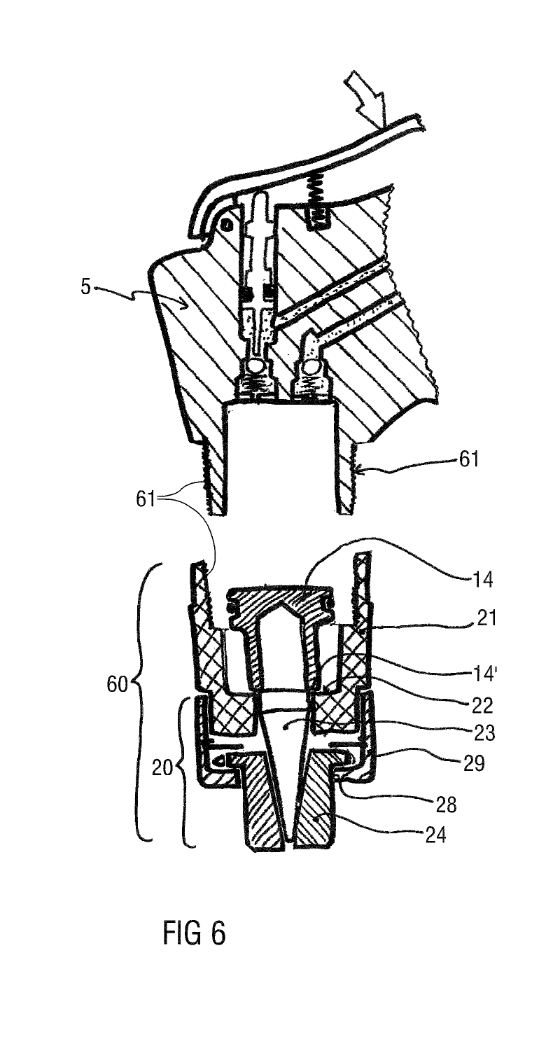

FIG. 6 shows the device or hydraulic tool 1 with an open hydraulic or pump head 5.

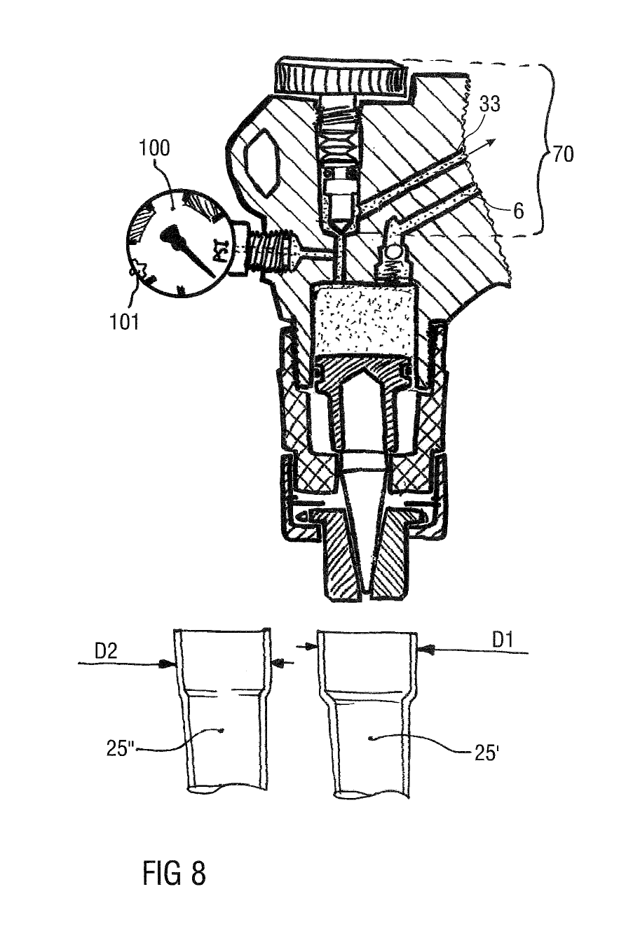

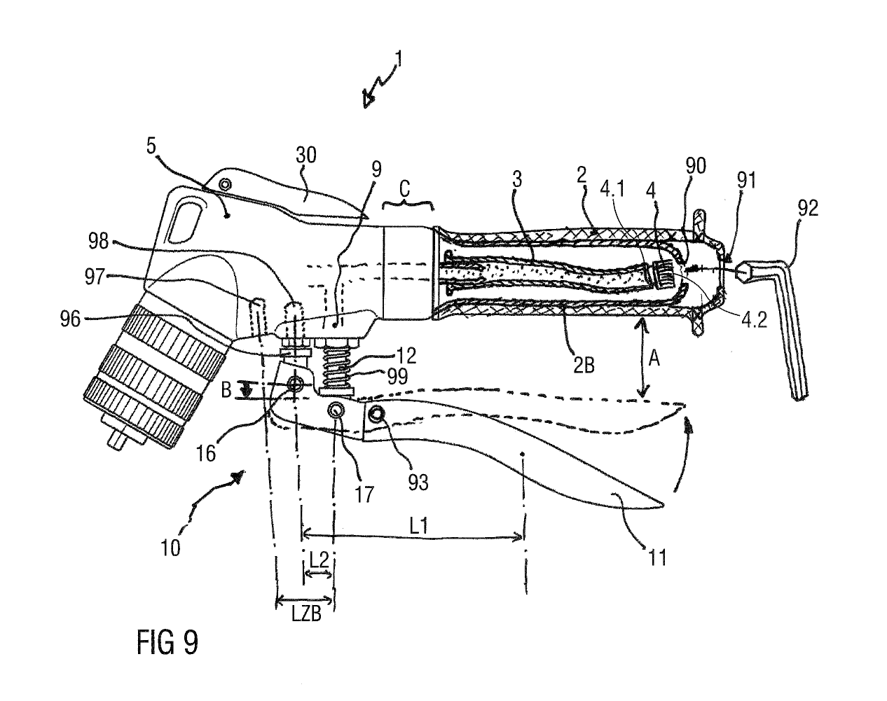

For further understanding of FIGS. 8 and 9, it can be seen that the entire lower unit or assembly 60 including tool set 20 and union nut 21 does not allow for any adjustment in respect of the hydraulic tool 1 or its expansion when the stop or shoulder 14′ of the actuator piston 14 contacts the counter-stop 22, not even if the position of the whole assembly 60 relative to the tool head 5, for example, by a rotation on a connecting thread 61, is changed relative to each other.

The main factor here is the stop or shoulder 14′ of the piston 14 at the stop 22 of the union nut 21, or the maximum stop within the tool set 20, which results from the diameter of the expansion stop 28 to which the jaws or pressing elements 24 are pressed.

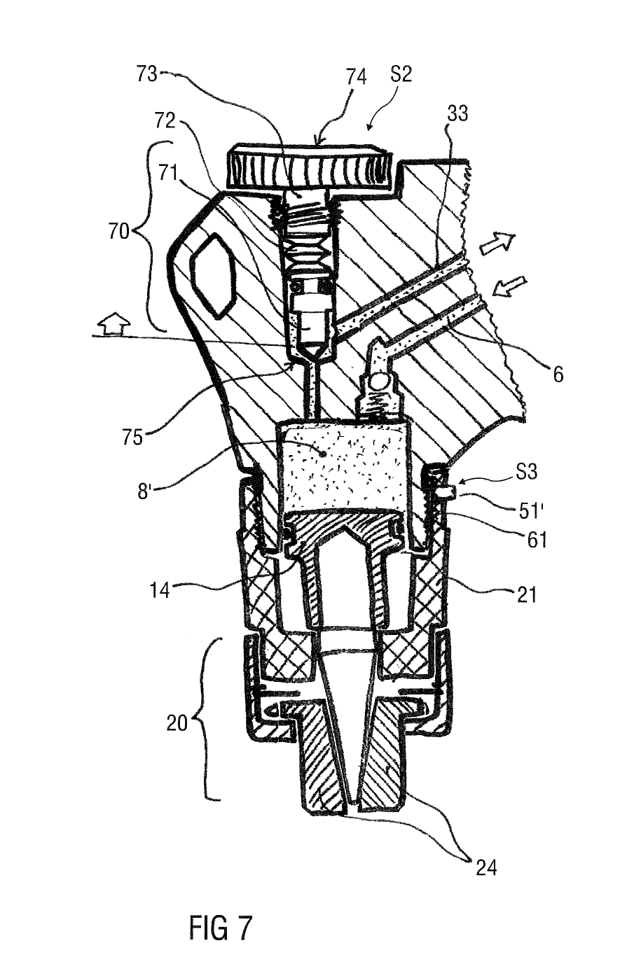

In contrast to FIG. 5 or 6, FIG. 7 shows an embodiment having a further securing element S2 for an adjustable hydraulic pressure limitation.

For this purpose, an overpressure valve 71, in particular a valve body, is inserted in the return line 33 as a securing element S2, said valve body being pressed into a sealing seat 75 by means of spring elements 72. The spring elements 72 are designed for this purpose, for example, as disc springs, but can also be spiral springs or other types of springs.

When pumping oil through the suction line 6, the pressure in the piston chamber 8′ is increased until the tool 20 with its jaws or pressing elements 24 expands up to a certain pressure.

At this pressure, which is defined by the pressure of the spring 99 or the spring element 72 over the valve body 71, the valve 71 opens and returns excess pressure into the tank 3 via the return line 33.

By means of an adjusting screw 73 with the rotary wheel 74, this maximum pressure can be previously set.

Via this pressure, a maximum opening, expansion or action of the additional tool 20, for example the pipe expanding tool, can then also be adjusted.

According to FIG. 7, the tool 1 can also comprise a screw 51′ as a further securing element S3, in particular as a locking element. The screw 51′ can be mounted using the union nut 21 with pressure on the connecting thread 61 of the hydraulic head or pump head 5.

This screw 51′ thereby secures the union nut 21 from slipping or twisting, or from an accidental opening of the hydraulic or piston chamber 8′. Oil leaks can thus be effectively prevented.

Union nut 21 labels always remain oriented in the right direction towards the user. In particular, the alignment with the hand pump not shown here can result in this screw 51′ not being accessible to users with conventional tools. In addition, it may also be covered with sealing wax.

The bore 50 in FIG. 4 can in particular be omitted in such an embodiment, when the screw 51′ engages the screw behind the outlet of the thread, where the thread is freely rotated. The tip of the screw 51′ with a tip angle of preferably 60 degrees or 90 degrees or 110 degrees then easily digs into the aluminum of the connecting thread 61 and the union nut 21.

FIG. 8 shows a further embodiment with a manometer or pressure gauge 100 at the hydraulic return path, of the return line 33 and of the tool 1 in the region of an overpressure valve assembly 70.

With this, the pressure and a different expansion D1, D2 of pipes 25′ and 25″ can be more closely monitored and more precisely manufactured.

Optionally, the manometer 100 has an alignment mark 101 for this purpose which also signals with a battery contact or a buzzer or a lamp once the desired final pressure is reached.

In particular, the manometer 100 has different scale divisions (here shown shaded) which are associated with applications, using icons or text, so that a user can see whether the correct, or a minimum, pressure has been reached. Especially with different adjustable leverage factors, it is possible to recognize whether the device was correctly installed and operated.

FIG. 9 shows the hydraulic tool 1, wherein the tank 3 integrated in the handle part 2 is preferably rubber-resilient. When suctioning with the pump 9, said tank contracts; upon release of the drain valve lever 30 and opening of the drain valve 32, the wall expands. The tank 3 is preferably made of PVC, TPE, NBR, or of a rubber material, wherein a screw hole is closed with a cover or a filling screw 4 or said tank is designed with a cover.

In particular, the handle part 2 is reinforced by an inner metallic sleeve 2B, which is screwed together with the hydraulic or pump head 5 in the range C. To refill the tank 3 with oil, said tank may be accessed by inserting a tool wrench 92 through an opening 91 and through an opening in the handle part 2, wherein said wrench positively engages in an opening 90 of the sleeve 2B.

The hand pump 9 is driven by the lever mechanism 10 loaded with a spring 99, wherein the pump piston 12 is operatively connected to the lever 11, the latter being in fluid communication with the piston cylinder system as an actuator 8, driving the latter. As a return spring, the spring 99 thereby pushes the lever mechanism 10, in particular the lever or handle 11, back to a neutral position, as shown, when it is not being operated.

The leverage factor of the pump 9 (also called pump leverage factor) is formed by the lever ratio, which is formed from 2 lengths. It is formed on the one hand by the handle length L1 from the middle of the grip surface of the lever 11 to the axis pivot point 16.

On the other hand, the lever ratio is formed from the piston length L2, which represents the distance between piston engagement point 17 and axis pivot point 16. According to the lever principle, a pump leverage factor of L1=100 mm to L2=15 mm, that is, 100:15 or 1.5 to 10 can be obtained as a transmission of force.

As an equivalent, depending on the design, the pump leverage factor can be variable with an aspect ratio of piston length L2 to lever length L1 in a range of 1:4 to 1:10, in particular 1:5 to 1:8.

The hydraulic piston diameter of the pump piston 12 in this case can be 5 mm to 15 mm, preferably 8 mm to 12 mm.

The lever ratio can be adapted to applications or pipes by relocating the axis pivot point 16 from its bore 98 into an empty, prepared bore 97. For this purpose, a bore 93 arranged in the handle 11 can be used as a new engagement point for the pump piston 12.

The pump leverage ratio then changes. The pump piston 12 is then controlled over the length LZB, which is preferably twice the length of L2. The lever 11, however, remains essentially the same, thus changing the force leverage ratios.

By threading the axis pivot point 16 at different depths, for example, by means of an adjustment element 96, in particular a screw or a nut, the dimensional position B of the axis pivot point 16 can be changed, thereby changing the opening dimension A of the lever 11 to the handle part 2, and can thus also be adjusted for smaller (shown in the dotted-line illustration) or larger (shown in the solid-line illustration) user hands.

The end pressure of the actuator 8 attainable, when operated by a human hand, is in a range of 200 bar to 750 bar, in particular 300 bar to 600 bar, preferably 350 bar to 500 bar.

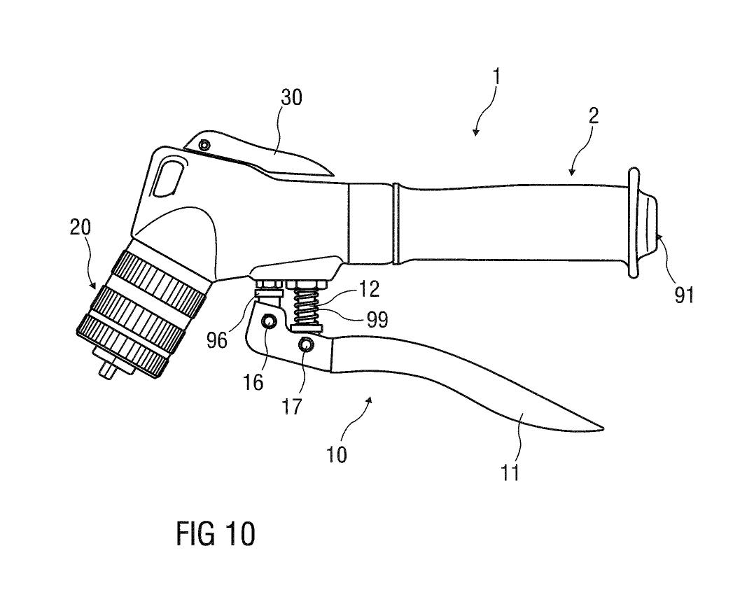

FIG. 10 shows schematically in side view an embodiment for a hydraulic tool 1 in the assembled state. The hydraulic tool 1 has the handle part 2 and the handle lever 11 which is pivotally mounted on the handle part 2.

Opposite the handle lever 11, the drain valve lever 30 is arranged on the handle part 2.

The pipe expanding tool 20 projects from the handle part 2 at its front end. In particular, the handle part 2 and the pipe expanding tool 20 are arranged at a predetermined angle, for example at an angle of greater than 90° and smaller than 180°, which in particular facilitates and supports handling of the hydraulic tool 1.

The opening 91 for a tool wrench 92 (shown in FIG. 9) is provided at the rear end of the handle part 2.

The hand pump 9 is driven by the lever mechanism 10 loaded with a spring 99, wherein the pump piston 12 is in operative connection with the lever 11, the former being in fluid communication with the piston cylinder system as an actuator 8, and driving the latter. In this case, the spring 99 presses back the lever mechanism 10, in particular the lever or handle 11, as a restoring spring into a neutral position, as shown, when said mechanism is not actuated.

The lever factor of the pump 9 (which can also be called the pump lever factor) is formed by the lever ratio, which is made up of 2 lengths. It is formed from the lever length L1 from the center of the handle surface of the lever 11 to the axis pivot point 16.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A hydraulic tool comprising:
a tank adapted to be filled with a fluid;
a pump unit connectable to the tank and in fluid communication with the tank, the pump unit comprising a pump piston with a pump piston surface; and
an actuator connected to the pump unit and in fluid communication with therewith,
wherein on the actuator, a receiving unit is arranged that forms a stop for an actuator piston with an actuator piston surface and/or on which a mechanical tool is adapted to be mounted,
wherein the actuator piston surface is a multiple of the pump piston surface, and
wherein upon activation, the pump unit engages in operative connection with the mechanical tool via the receiving unit.

2. A hydraulic tool comprising:
a tank adapted to be filled with a fluid;
a pump unit connectable to the tank and in fluid communication with the tank, the pump unit a pump piston with a pump piston surface;
an actuator connected to the pump unit in fluid communication therewith, wherein on the actuator, a receiving unit is arranged that forms a stop for an actuator piston with an actuator piston surface and/or on which a mechanical tool is adapted to be mounted; and
at least one securing element for pressure limitation, for fluid exchange, and/or for preventing twisting.

3. The hydraulic tool according to claim 2, wherein the securing element engages in the actuator such that fluid exchange is made possible.

4. The hydraulic tool according to claim 2, wherein the securing element engages in the receiving unit such that the receiving unit is secured at least against twisting.

5. The hydraulic tool according to claim 2, wherein the securing element engages in the fluid connection such that a pressure limitation is made possible or is made adjustable.

6. The hydraulic tool according to claim 2, wherein, for preventing twisting, the securing element is a screw or a round-pin or a form locking element, which secures the receiving unit against twisting.

7. The hydraulic tool according to claim 2, wherein the pump unit has a spring-loaded lever mechanism, which is in operative connection with the pump piston.

8. The hydraulic tool according to claim 2, wherein the receiving unit is formed as a union nut, which is mounted on an actuator piston cylinder unit.

9. The hydraulic tool according to claim 2, wherein the receiving unit couples the pump unit and the actuator with a mechanical tool.

10. The hydraulic tool according to claim 2, wherein, as a pump leverage factor, a length ratio is formed from the lever length of the handle surface of the lever to the axis pivot point and of the piston length of the piston engagement point to the axis pivot point.

11. The hydraulic tool according to claim 2, wherein the pump leverage factor is variable and has a length ratio of lever length to piston length in a range from 1:4 to 1:10, or 1:5 to 1:8.

12. The hydraulic tool according to claim 2, wherein a hydraulic piston diameter of the pump piston has a diameter of 5 mm to 15, or 8 mm to 12 mm.

13. The hydraulic tool according to claim 2, wherein the tank is provided with an end cap or a cap screw, which has a tool holder or a hexagonal hole, at the outwardly pointing end.

14. The hydraulic tool according to claim 2, wherein an attainable end pressure when manually activated by a human hand is 200 bar to 750 bar or 300 bar to 600 bar or 350 bar to 500 bar.

15. A hydraulic tool comprising:
a tank adapted to be filled with a fluid;
a pump unit connected in fluid communication with the tank;
an actuator in fluid communication with the pump unit; and
a fluid change device via which a fluid connection to the tank is adapted to be set without the use of tools.

16. A hydraulic tool comprising:
a tank adapted to be filled with a fluid;
a pump unit connected in fluid communication with the tank; and
an actuator in fluid communication with the pump unit;
wherein the pump unit comprises, as an actuating element, a lever mechanism of which an axis pivot point is adjustable.

17. A hydraulic tool comprising:
a tank adapted to be filled with a fluid;
a pump unit;
an actuator;
at least one fluid connection for the fluidic connection of the tank, the pump unit and the actuator; and
a manometer that is at least fluidically connected to the at least one fluid connection and/or a piston chamber.
